(19) United States
(12) Patent Application Publication
(10) Pub. No.: US 2018/0351736 A1
(43) Pub. Date: Dec. 6, 2018

(54) Session Key Negotiation Method, Apparatus, and System

(71) Applicant: Huawei Technologies Co., Ltd., Shenzhen (CN)

(72) Inventors: Hao Lei, Beijing (CN); Wenping Ma, Xi'an (CN)

(21) Appl. No.: 16/055,660

(22) Filed: Aug. 6, 2018

Related U.S. Application Data
(63) Continuation of application No. PCT/CN2017/070797, filed on Jan. 10, 2017.

(30) Foreign Application Priority Data
Feb. 4, 2016 (CN) 201610079672.5

(51) Int. Cl. H04L 9/08; H04W 12/04; H04L 9/32; H04L 29/06

(52) U.S. Cl. CPC H04L 9/0838; H04W 12/04; H04L 63/067; H04L 63/0823; H04L 9/3263

(57) ABSTRACT

A session key negotiation method, apparatus, and system, where the session key negotiation method in the present disclosure includes obtaining, by first user equipment, a vector (σ_{B}) according to a long-term private key (s_{B}) and a temporary private key (y_{B}) that correspond to the first user equipment, and a received long-term public key (P_{A}) and a received temporary public key (x_{A}) that correspond to second user equipment performing session negotiation with the first user equipment, calculating and obtaining a v̅_{B} according to the σ_{B} using a formula v̅_{B}=dbl(σ_{B}), obtaining a semaphore (v_{B}) according to the v̅_{B} using a formula v_{B}= [symbol] v̅_{B} [symbol] ₂, and calculating and obtaining a session key (K) according to the v_{B} using a formula

$$K = {[ {\overline{v}}_{B} ]}_{2} = [ \frac{2}{q} g {\overline{v}}_{B} ] ,$$

where q is an even number not equal to two.

### CROSS-REFERENCE TO RELATED APPLICATIONS

This application is a continuation of International Patent Application No. PCT/CN2017/070797 filed on Jan. 10, 2017, which claims priority to Chinese Patent Application No. 201610079672.5 filed on Feb. 4, 2016. The disclosures of the aforementioned applications are hereby incorporated by reference in their entireties.

### TECHNICAL FIELD

The present disclosure relates to information security and communications technologies, and in particular, to a session key negotiation method, apparatus, and system.

### BACKGROUND

A key exchange protocol in the other approaches can ensure that two or more users establish a shared session key in a public network environment by exchanging information. The users participating in communication encrypt communication data using the shared session key to ensure security of network communication. An authentication key exchange protocol is key negotiation with an authentication function, and can authenticate identities of two parties participating in the key negotiation, thereby effectively defending against an attack from a third party.

Currently, a working principle of the authentication key exchange protocol is mainly as follows. For randomly selected a∈R_{q}, according to R-DLWE_{q,x}, a party A and a party B requiring authentication key negotiation (1) respectively select (s_{A},e_{A})←χ and (s_{B},e_{B})←χ secretly, (2) respectively calculate b_{A}=ags_{A}+e_{A} and b_{B}=ags_{B}+e_{B}, where b_{A} and b_{B} are public, and (3) respectively calculate s_{A}gb_{B} and s_{B}gb_{A} using respective keys s_{A} and s_{B}. Because s_{A}gb_{B}=s_{A}as_{B}+s_{A}e_{B}≈s_{A}as_{B}≈s_{B}as_{A}+s_{B}e_{A}=s_{B}gb_{A}, s_{A}gb_{B}−s_{B}gb_{A}=s_{A}e_{B}−s_{B}e_{A}. If a difference ∥s_{A}e_{B}−s_{B}e_{A}∥ between the two parties is within a particular range, the two parties may cancel the error, and calculate a common secret s_{A}as_{B}. Because s_{A}as_{B} is related to only the respective keys s_{A} and s_{B} of the two parties, only the party A and the party B know s_{A}as_{B}.

In addition, to cancel the error ∥s_{A}e_{B}−s_{B}e_{A}∥ such that the both parties can correctly recover s_{A}as_{B}, a characteristic function Cha(v) and a modular function Mod₂(w,b) are mainly used such that the two parties recover common information s_{A}as_{B}. The characteristic function Cha(v) is defined as follows:

$$Cha ( v ) \text{:} {¢}_{q} \to {¢}_{2} \text{:} where v ∈ {¢}_{q} = \{ - \frac{q - 1}{2} , L , \frac{q - 1}{2} \} \text{:}$$

$$Cha ( v ) = \{ \begin{matrix}0 & v ∈ E = \{ - ⌊ \frac{q}{4} ⌋ , L , [ \frac{q}{4} ] \} \\ 1 & v ∈ \{ - \frac{q - 1}{2} , L , \frac{q - 1}{2} \} - E\end{matrix} .$$

The modular function Mod₂(w,b) is defined as follows:

$${Mod}_{2} ( w , b ) \text{:} {¢}_{q} \times {¢}_{2} \to {¢}_{2} , where v ∈ {¢}_{q} and b ∈ {¢}_{2} \text{:}$$

$${Mod}_{2} ( v , b ) = ( v + b \cdot \frac{q - 1}{2} ) mod q mod 2.$$

Further, s_{A}as_{B} is recovered bit by bit using the modular function Mod₂(w,b). Using one bit as an example, q is an odd prime, and b=Cha(v)∈¢₂ is given. For w=v+2e, if an error is e∈¢_{q}, and |e|<q/2, Mod₂(v,Cha(v))=Mod₂(w,Cha(v)). In other words, when a distance between w and v is within a particular range (w=v+2e), the two parties each may calculate one common secret bit b̅ based on w,v using the common characteristic function Cha(v) and the modular function Mod₂(w,b):

Mod₂(v,Cha(v))=b̅=Mod₂(w,Cha(v)).

When q is an odd prime and w,v∈_{R}¢_{q} is given:

1. if Cha(v)=0, a deviation in outputting 0/1 from Mod₂(w,Cha(v)) is 1/2|E|; or

2. if Cha(v)=1, a deviation in outputting 0/1 from Mod₂(w,Cha(v)) is 1/(|E|−1).

However, a common secret bit b̅∈{0,1} calculated using the modular function Mod₂(w,Cha(v)) is not evenly distributed. Therefore, to prevent a third party from obtaining one bit of a key and therefore affecting security during use, in the other approaches, the odd prime q needs to be sub-exponential, leading to problems of increasing traffic and calculation costs. In addition, in the other approaches, a power basis is further used to represent an element on a quotient ring R_{q}=¢_{q}[x]/(xⁿ+1), and n=2^{k}. For an expression of the power basis on the quotient ring R_{q}, a larger size of the power basis indicates a larger size of the element on the quotient ring R_{q}, and therefore, the problems of heavy traffic and high calculation costs are caused.

### SUMMARY

The present disclosure provides a session key negotiation method, apparatus, and system, to resolve problems of heavy traffic and high calculation costs in the other approaches.

A first aspect of the present disclosure provides a session key negotiation method, including receiving, by first user equipment, a long-term public key P_{A} and a temporary public key x_{A} that correspond to second user equipment performing session negotiation with the first user equipment, obtaining, by the first user equipment, a vector σ_{B} according to a long-term private key s_{B} and a temporary private key y_{B} that correspond to the first user equipment, the long-term public key P_{A}, and the temporary public key x_{A}, obtaining, by the first user equipment, v̅_{B} according to the vector σ_{B} using a formula v̅_{B}=dbl(σ_{B}), obtaining, by the first user equipment, a semaphore v_{B} according to v̅_{B} using a formula v_{B}= [symbol] v̅_{B} [symbol] ₂, and obtaining, by the first user equipment, a session key K according to the semaphore v_{B} using a formula

$$K = {[ {\overline{v}}_{B} ]}_{2} = [ \frac{2}{q} g {\overline{v}}_{B} ] ,$$

where q is an even number and is not equal to 2.

With reference to the first aspect, it may be understood that a manner of obtaining a vector σ_{B} may be obtaining, by the first user equipment, the temporary private key y_{B} according to system parameters a and f_{B} using a formula y_{B}=agr_{B}+f_{B}∈R_{q}, obtaining, by the first user equipment, d and e according to the temporary public key x_{A} corresponding to the second user equipment, the temporary private key y_{B} corresponding to the first user equipment, identity information B corresponding to the first user equipment, and identity information A corresponding to the second user equipment using formulas d=H(x_{A},B) and e=H(y_{B},A) respectively, and obtaining, by the first user equipment, σ_{B} according to the long-term private key s_{B} and the temporary private key r_{B} that correspond to the first user equipment, the long-term public key P_{A} and the temporary public key x_{A} that correspond to the second user equipment, d, and e using a formula σ_{B}=gg(x_{A}+dgP_{A})g(r_{B}+egs_{B})∈R_{q}, where a∈R_{q}=¢_{q}[ζₘ], r_{B}←χ, f_{B}←χ, g is a system parameter, and g∈R, R is a cyclotomic ring, and R_{q} is a quotient ring defined on

$$R = ¢ [ {ζ}_{m} ] = \frac{¢ [ x ]}{{Φ}_{m} ( x )} ,$$

and m is a positive integer.

With reference to the first aspect, optionally, the identity information A and B are bit strings representing identity card numbers or fingerprint information.

With reference to the first aspect, it should be noted that the method further includes obtaining, by the first user equipment, a long-term public key P_{B} corresponding to the first user equipment according to s₁ and e₁ using a formula P_{B}=ags₁+e₁∈R_{q}, sending, by the first user equipment, a registration request carrying the long-term public key P_{B} to an authentication center such that when authenticating, according to the registration request, that the long-term public key P_{B}≠0, the authentication center obtains b_{c}, [v]₂, and [symbol] v [symbol] ₂ according to s, e, and e′ using formulas b_{c}=ags+e and v=ggbgs+e′, and returns b_{c} and [symbol] v [symbol] ₂ to the first user equipment, and obtaining, by the first user equipment, w according to the received b_{c} and [symbol] v [symbol] ₂ using formulas u=ggb_{c}gs₁ and w=rec(u, [symbol] v [symbol] ₂), and sending w to the authentication center such that when authenticating that w=[v]₂, the authentication center sends a first certificate Cert_{B} to the first user equipment, to certify that the first user equipment owns the long-term public key P_{B}, where s₁, e₁←χ, s, e, and e′←χ.

With reference to the first aspect, optionally, the method further includes sending, by the first user equipment, the long-term public key P_{B}, the temporary private key y_{B}, and the semaphore v_{B} of the first user equipment to the second user equipment such that the second user equipment obtains the session key K within a preset error range according to a long-term private key s_{A} and the temporary private key r_{A} that correspond to the second user equipment, the long-term public key P_{B}, the temporary private key y_{B}, and the semaphore v_{B}, where the preset error range is

$$[ - \frac{q}{8} , \frac{q}{8} ) .$$

A second aspect of the present disclosure provides a session key negotiation method, including receiving, by second user equipment, a long-term public key P_{B}, a semaphore v_{B}, and a temporary private key y_{B} that are of first user equipment performing session negotiation with the second user equipment and that are sent by the first user equipment, obtaining, by the second user equipment, a vector σ_{A} according to a long-term private key s_{A} and a temporary private key x_{A} that correspond to the second user equipment, the long-term public key P_{B}, and the temporary private key y_{B}, and obtaining, by the second user equipment, a session key K corresponding to the second user equipment within the preset error range according to the vector σ_{A} and the semaphore v_{B} using a formula K=rec(σ_{A},v_{B}), where the preset error range is

$$[ - \frac{q}{8} , \frac{q}{8} ) ,$$

and q is an even number and is not equal to 2.

With reference to the second aspect, it should be noted that the method further includes the obtaining, by the second user equipment, a vector σ_{A} according to a long-term private key s_{A} and a temporary public key x_{A} that correspond to the second user equipment, the long-term public key P_{B}, and the temporary private key y_{B} includes obtaining, by the second user equipment, the temporary public key x_{A} according to system parameters a and f_{A} using a formula x_{A}=agr_{A}+f_{A}∈R_{q}, obtaining, by the second user equipment, d and e according to the temporary private key x_{A} corresponding to the first user equipment, the temporary private key y_{B}, identity information B corresponding to the first user equipment, and identity information A corresponding to the second user equipment using formulas d=H(x_{A},B) and e=H(y_{B},A) respectively, and obtaining, by the second user equipment, the vector σ_{A} according to the long-term private key s_{A} corresponding to the second user equipment, the long-term public key P_{B} and the temporary private key y_{B} that correspond to the first user equipment, d, and e using a formula σ_{A}=gg(y_{B}+dgP_{B})g(r_{A}+egs_{A})∈R_{q}, where a∈R_{q}=¢_{q}[ζₘ], r_{A}←χ, f_{A}←χ, g is a system parameter, and g∈R, R is a cyclotomic ring, and R_{q} is a quotient ring defined on

$$R = ¢ [ {ζ}_{m} ] = \frac{¢ [ x ]}{Φ ( x )} ,$$

and m is a positive integer.

With reference to the second aspect, optionally, the identity information A and B are bit strings representing identity card numbers or fingerprint information.

With reference to the second aspect, it may be understood that the method further includes obtaining, by the second user equipment, a long-term public key P_{A} corresponding to the first user equipment according to s₁ and e₁ using a formula P_{A}=ags₁+e₁∈R_{q}, sending, by the second user equipment, a registration request carrying the long-term public key P_{A} to an authentication center such that when authenticating, according to the registration request, that P_{A}≠0, the authentication center obtains b_{c}, [v]₂, and [symbol] v [symbol] ₂ according to s, e, and e′ using formulas b_{c}=ags+e and v=ggbgs+e′, and returns b_{c} and [symbol] v [symbol] ₂ to the second user equipment, and obtaining, by the second user equipment, w according to the received b_{c} and [symbol] v [symbol] ₂ using formulas u=ggb_{c}gs₁ and w=rec(u, [symbol] v [symbol] ₂), and sending w to the authentication center such that when authenticating that w=[v]₂, the authentication center sends a second certificate Cert_{A} to the second user equipment, to certify that the second user equipment owns the long-term public key P_{A}, where s₁, e₁←χ, s, e, and e′←χ.

A third aspect of the present disclosure provides a session key negotiation apparatus, including a transceiver module configured to receive a long-term public key P_{A} and a temporary public key x_{A} that correspond to second user equipment performing session negotiation with the session key negotiation apparatus, a vector obtaining module configured to obtain a vector σ_{B} according to a long-term private key s_{B} and a temporary private key y_{B} that correspond to the session key negotiation apparatus, the long-term public key P_{A}, and the temporary public key x_{A}, a first calculation module configured to obtain v̅_{B} according to the vector σ_{B} using a formula v̅_{B}=dbl(σ_{B}), a semaphore obtaining module configured to obtain a semaphore v_{B} according to v̅_{B} using a formula v_{B}= [symbol] v̅_{B} [symbol] ₂, and a session key obtaining module configured to obtain a session key K according to the semaphore v_{B} using a formula

$$K = {[ {\overline{v}}_{B} ]}_{2} = [ \frac{2}{q} g {\overline{v}}_{B} ] ,$$

where q is an even number and is not equal to 2.

With reference to the third aspect, it may be understood that the vector obtaining module in the apparatus includes a temporary private key obtaining unit configured to obtain the temporary private key y_{B} according to system parameters a and f_{B} using a formula y_{B}=agr_{B}+f_{B}∈R_{q}, a calculation unit configured to obtain d and e according to the temporary public key x_{A} corresponding to the second user equipment, the temporary private key y_{B} corresponding to the first user equipment, identity information B corresponding to the session key negotiation apparatus, and identity information A corresponding to the second user equipment using formulas d=H(x_{A},B) and e=H(y_{B},A) respectively, and a vector obtaining unit configured to obtain σ_{B} according to the long-term private key s_{B} and the temporary private key r_{B} that correspond to the session key negotiation apparatus, the long-term public key P_{A} and the temporary public key x_{A} that correspond to the second user equipment, d, and e using a formula σ_{B}=gg(x_{A}+dgP_{A})g(r_{B}+egs_{B})∈R_{q}, where a∈R_{q}=¢_{q}[ζₘ], r_{B}←χ, f_{B}←χ, g is a system parameter, and g∈R, R is a cyclotomic ring, and R_{q} is a quotient ring defined on

$$R = ¢ [ {ζ}_{m} ] = \frac{¢ [ x ]}{{Φ}_{m} ( x )} ,$$

and m is a positive integer.

With reference to the third aspect, it may be pointed out that the apparatus further includes a long-term public key obtaining module configured to obtain a long-term public key P_{B} corresponding to the session key negotiation apparatus according to s₁ and e₁ using a formula P_{B}=ags₁+e₁∈R_{q}, where the transceiver module is further configured to send a registration request carrying the long-term public key P_{B} to an authentication center such that when authenticating, according to the registration request, that the long-term public key P_{B}≠0, the authentication center obtains b_{c}, [v]₂, and [symbol] v [symbol] ₂ according to s, e, and e′ using formulas b_{c}=ags+e and v=ggbgs+e′, and returns b_{c} and [symbol] v [symbol] ₂ to the session key negotiation apparatus, and a second calculation module configured to obtain w according to the received b_{c} and [symbol] v [symbol] ₂ using formulas u=ggb_{c}gs₁ and w=rec(u, [symbol] v [symbol] ₂), where the transceiver module is further configured to send w to the authentication center such that when authenticating that w=[v]₂, the authentication center sends a first certificate Cert_{B} to the session key negotiation apparatus, to certify that the session key negotiation apparatus owns the long-term public key P_{B}, where s₁, e₁←χ, s, e, and e′←χ.

With reference to the third aspect, optionally, the transceiver module is further configured to send the long-term public key P_{B}, the temporary private key y_{B}, and the semaphore v_{B} of the session key negotiation apparatus to the second user equipment such that the second user equipment obtains the session key K within a preset error range according to a long-term private key s_{A} and the temporary private key r_{A} that correspond to the second user equipment, the long-term public key P_{B}, the temporary private key y_{B}, and the semaphore v_{B}, where the preset error range is

$$[ - \frac{q}{8} , \frac{q}{8} ) .$$

A fourth aspect of the present disclosure provides a session key negotiation apparatus, including a transceiver module configured to receive a long-term public key P_{B}, a semaphore v_{B}, and a temporary private key y_{B} that are of first user equipment performing session negotiation with the session key negotiation apparatus and that are sent by the first user equipment, a vector obtaining module configured to obtain a vector σ_{A} according to a long-term private key s_{A} and a temporary private key x_{A} that correspond to the session key negotiation apparatus, the long-term public key P_{B}, and the temporary private key y_{B}, and a session key obtaining module configured to obtain a session key K corresponding to the session key negotiation apparatus within the preset error range according to the vector σ_{A} and the semaphore v_{B} using a formula K=rec(σ_{A},v_{B}), where the preset error range is

$$[ - \frac{q}{8} , \frac{q}{8} ) ,$$

and q is an even number and is not equal to 2.

With reference to the fourth aspect, it may be pointed out that the vector obtaining module in the apparatus includes a temporary private key obtaining unit configured to obtain a temporary public x_{A} according to system parameters a and f_{A} using a formula x_{A}=agr_{A}+f_{A}∈R_{q}, a calculation unit configured to obtain d and e according to the long-term public key P_{B} and the temporary public key x_{A} that correspond to the first user equipment, the temporary private key y_{B}, identity information B corresponding to the first user equipment, and identity information A corresponding to the session key negotiation apparatus using formulas d=H(x_{A},B) and e=H(y_{B},A) respectively, and a vector obtaining unit configured to obtain the vector σ_{A} according to the long-term private key s_{A} corresponding to the session key negotiation apparatus, the long-term public key P_{B} and the temporary private key y_{B} that correspond to the first user equipment, d, and e using a formula σ_{A}=gg(y_{B}+dgP_{B})g(r_{A}+egs_{A})∈R, where a∈R_{q}=¢_{q}[ζₘ], r_{A}←χ, f_{A}←χ, g is a system parameter, and g∈R, R is a cyclotomic ring, and R_{q} is a quotient ring defined on

$$R = ¢ [ {ζ}_{m} ] = \frac{¢ [ x ]}{Φ ( x )} ,$$

and m is a positive integer.

With reference to the fourth aspect, optionally, the apparatus further includes a long-term public key obtaining module configured to obtain a long-term public key P_{A} corresponding to the second user equipment according to s₁ and e₁ using a formula P_{A}=ags₁+e₁∈R_{q}, where the transceiver module is further configured to send a registration request carrying the long-term public key P_{A} to an authentication center such that when authenticating, according to the registration request, that P_{A}≠0, the authentication center obtains b_{c}, [v]₂, and [symbol] v [symbol] ₂ according to s, e, and e′ using formulas b_{c}=ags+e and v=ggbgs+e′, and returns b_{c} and [symbol] v [symbol] ₂ to the session key negotiation apparatus, and a calculation module configured to obtain w according to the received b_{c} and [symbol] v [symbol] ₂ using formulas u=ggb_{c}gs₁ and w=rec(u, [symbol] v [symbol] ₂), where the transceiver module is further configured to send w to the authentication center such that when authenticating that w=[v]₂, the authentication center sends a second certificate Cert_{A} to the session key negotiation apparatus, to certify that the session key negotiation apparatus owns the long-term public key P_{A}, where s₁, e₁←χ, s, e, and e′←χ.

A fifth aspect of the present disclosure provides a session key negotiation system, including first user equipment and second user equipment that performs session negotiation with the first user equipment, where the first user equipment is the session key negotiation apparatus described in the third aspect, and the second user equipment is the session key negotiation apparatus described in the fourth aspect.

With reference to the fifth aspect, it may be understood that the first user equipment and the second user equipment in the system are in a distributed network environment.

In the session key negotiation method, apparatus, and system in the embodiments of the present disclosure, the first user equipment obtains the vector σ_{B} according to the long-term private key s_{B} and the temporary private key y_{B} that correspond to the first user equipment and the received long-term public key P_{A} and temporary public key x_{A} that correspond to the second user equipment performing session negotiation with the first user equipment, obtains the semaphore v_{B} according to the vector σ_{B} using a randomized function and a cross-rounding function, and calculates and obtains the session key K according to the semaphore v_{B} using a modulo-2 rounding function. If x∈¢_{q} is randomly uniform, the modulo-2 rounding function [x]₂ is uniformly distributed on ¢₂, thereby effectively ensuring security of the session key. In addition, because q is an even number, the problems in the other approaches that the traffic and calculation costs are increased are further effectively resolved.

### BRIEF DESCRIPTION OF DRAWINGS

To describe the technical solutions in the embodiments of the present disclosure more clearly, the following briefly describes the accompanying drawings required for describing the embodiments or the other approaches. The accompanying drawings in the following description show some embodiments of the present disclosure, and persons of ordinary skill in the art may still derive other drawings from these accompanying drawings without creative efforts.

FIG. 1 is a schematic diagram of a network architecture that serves as a basis of a session key negotiation method according to the present disclosure;

FIG. 2 is a diagram of a negotiation running process of session key negotiation according to the present disclosure;

FIG. 3 is a flowchart of Embodiment 1 of a session key negotiation method according to the present disclosure;

FIG. 4 is a flowchart of Embodiment 2 of a session key negotiation method according to the present disclosure;

FIG. 5A and FIG. 5B are flowcharts of Embodiment 3 of a session key negotiation method according to the present disclosure;

FIG. 6 is a flowchart of Embodiment 4 of a session key negotiation method according to the present disclosure;

FIG. 7 is a flowchart of Embodiment 5 of a session key negotiation method according to the present disclosure;

FIG. 8 is a flowchart of Embodiment 6 of a session key negotiation method according to the present disclosure;

FIG. 9 is a schematic structural diagram of Embodiment 1 of a session key negotiation apparatus according to the present disclosure;

FIG. 10 is a schematic structural diagram of Embodiment 2 of a session key negotiation apparatus according to the present disclosure;

FIG. 11 is a schematic structural diagram of Embodiment 3 of a session key negotiation apparatus according to the present disclosure;

FIG. 12 is a schematic structural diagram of Embodiment 4 of a session key negotiation apparatus according to the present disclosure;

FIG. 13 is a schematic structural diagram of Embodiment 5 of a session key negotiation apparatus according to the present disclosure;

FIG. 14 is a schematic structural diagram of Embodiment 6 of a session key negotiation apparatus according to the present disclosure; and

FIG. 15 is a schematic structural diagram of user equipment according to an embodiment of the present disclosure.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. The described embodiments are some but not all of the embodiments of the present disclosure. All other embodiments obtained by persons of ordinary skill in the art based on the embodiments of the present disclosure without creative efforts shall fall within the protection scope of the present disclosure.

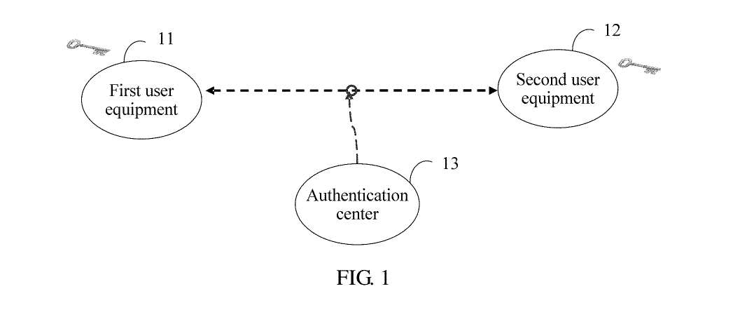

FIG. 1 is a schematic diagram of a network architecture that serves as a basis of a session key negotiation method according to the present disclosure. As shown in FIG. 1, the network architecture mainly includes first user equipment 11 and second user equipment 12. Session key negotiation between the first user equipment 11 and the second user equipment 12 is performed in a distributed network environment. That is, only the first user equipment 11 and the second user equipment 12 know a session key established between the first user equipment and the second user equipment, and no third party knows the session key. In addition, optionally, the network architecture may further include an authentication center 13. That is, before the first user equipment 11 and the second user equipment 12 perform session key negotiation, authentication needs to be performed. That is, the first user equipment 11 can determine that it is the second user equipment 12, but not another device, that performs key negotiation with the first user equipment. Similarly, the second user equipment 12 can determine that it is the first user equipment, but not another device, that performs key negotiation with the second user equipment.

In the present disclosure, a current protocol is constructed on a quotient ring R_{q} of a cyclotomic ring

$$R = ¢ [ {ζ}_{m} ] = \frac{¢ [ x ]}{{Φ}_{m} ( x )} .$$

System parameters are further descxribed as follows: m is a positive integer, and describes a regulation of the m-order cyclotomic ring

$$R = ¢ [ {ζ}_{m} ] = \frac{¢ [ x ]}{{Φ}_{m} ( x )} ,$$

and a degree of Φₘ(x) is n=φ(m), q is an odd prime: qcd(q,m)=1, g=Πₚ(1−zₚ), and p traverses all odd primes that can be exactly divided by m, [ψ] is discrete Gaussian distribution on an algebraic number field K, and

$$ψ = {D}_{\sqrt{2} r} ,$$

H(⋅):{0,1}*→R: any string is mapped to an element that satisfies the discrete Gaussian distribution χ=[ψ] and that is located on R=¢[ζₘ], and a∈R_{q}=¢_{q}[ζₘ] a global public parameter.

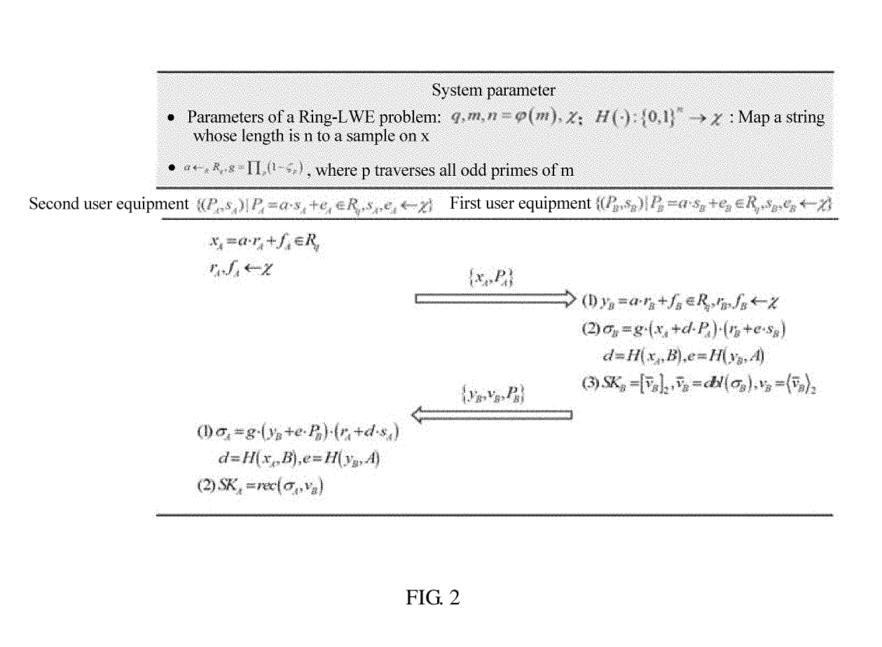

In addition, each of the first user equipment 11 and the second user equipment 12 is identified using a pair of a long-term public key and a long-term private key. A generation manner is simply described as follows. Using the second user equipment 12 as an example, the second user equipment 12 samples s_{A}←χ and e_{A}←χ, where e_{A} is a noise vector, and uses s_{A}∈R_{q} as a long-term private key of the second user equipment, calculates P_{A}=a·s_{A}+e_{A}∈R_{q}, and uses P_{A}=a·s_{A}+e_{A}∈R_{q} as a long-term public key of the second user equipment. It is assumed that a session key K to be negotiated about between the first user equipment 11 and the second user equipment 12 may be K=SK_{AB}. FIG. 2 is a diagram of a negotiation running process of session key negotiation. That is, a specific negotiation process is shown in FIG. 2.

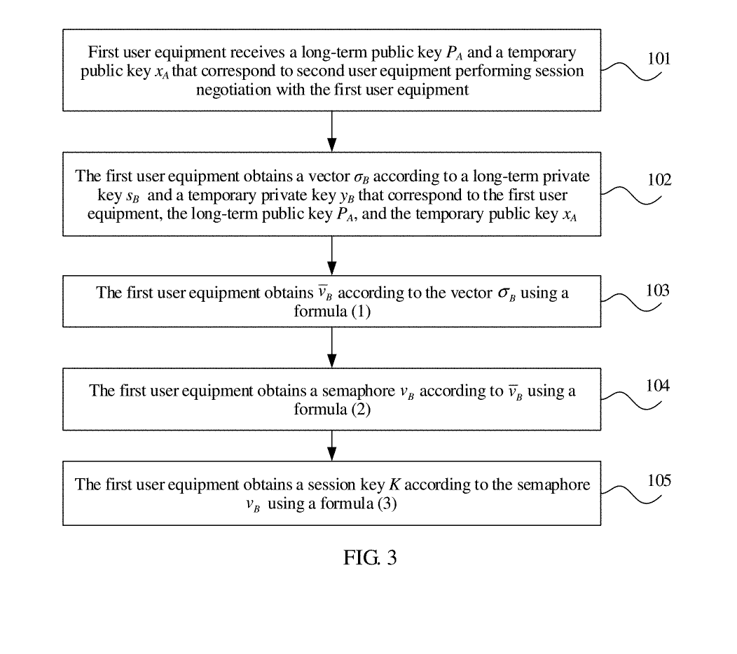

FIG. 3 is a flowchart of Embodiment 1 of a session key negotiation method according to the present disclosure. As shown in FIG. 3, the method in this embodiment may include the following steps.

Step 101. First user equipment receives a long-term public key P_{A} and a temporary public key x_{A} that correspond to second user equipment performing session negotiation with the first user equipment.

Step 102. The first user equipment obtains a vector σ_{B} according to a long-term private key s_{B} and a temporary private key y_{B} that correspond to the first user equipment, the long-term public key P_{A}, and the temporary public key x_{A}.

In this embodiment, session key negotiation between the first user equipment and the second user equipment is performed in a distributed network environment.

Step 103. The first user equipment obtains v̅_{B} according to the vector σ_{B} using a formula (1):

v̅_{B}=dbl(σ_{B}) (1)

In this embodiment, dbl represents a randomized function.

Step 104. The first user equipment obtains a semaphore v_{B} according to v̅_{B} using a formula (2):

v_{B}= [symbol] v̅_{B} [symbol] ₂ (2)

In this embodiment, v_{B} is a “semaphore” obtained after v̅_{B} is input to a cross-rounding function. A cross-rounding function [symbol] [symbol] ₂: ¢_{q}→¢₂ is defined as

$$x a ⌊ \frac{4}{q} gx ⌋ mod 2.$$

With reference to definitions of the following modulo-2 rounding function and cross-rounding function, a relationship between an interval of x∈¢_{q} and a value of [symbol] x [symbol] ₂ is as follows:

$${〈 x 〉}_{2} = b ⇔ x ∈ {I}_{b} U ( \frac{q}{2} + {I}_{b} ) , ∀ b ∈ \{ 0 , 1 \} .$$

In addition, for an even number q, if x∈¢_{q} is randomly uniform, and [symbol] x [symbol] ₂ is given, [x]₂ is evenly distributed on ¢₂={0,1}. That is, for evenly distributed x∈¢_{q}, [symbol] x [symbol] ₂=b is given. In this case, a probability of [x]₂=b and a probability of [x]₂=1−b are both 1/2. That is, [symbol] x [symbol] ₂=b is given, if x∈¢_{q} is not leaked, [x]₂ is secure in terms of information theory.

Step 105. The first user equipment obtaining a session key K according to the semaphore v_{B} using a formula (3):

$$K = {[ {\overline{v}}_{B} ]}_{2} = [ \frac{2}{q} g {\overline{v}}_{B} ] \qquad ( 3 )$$

Furthermore, the q is an even number and is not equal to 2.

In this embodiment, a modulo-2 rounding function [ ]₂: ¢_{q}→¢₂ is defined as

$$[ \frac{2}{q} gx ] .$$

For x∈¢_{q}, an absolute minimum complete residue system

$$I = \{ - \frac{q}{2} , - \frac{q}{2} + 1 , L , 0 , 1 , L \frac{q}{2} - 1 \}$$

of ¢_{q} is used, and q is an even number and is not 2:

(1). I₀={0,1,2,L,[q/4]−1}, I₁={−[q/4],L,−1}mod q, and I₀UI₁ enables [x]₂=0; and

(2).

$$( \frac{q}{2} + {I}_{0} ) U ( \frac{q}{2} + {I}_{1} )$$

includes all elements that enable [x]₂=1.

In this embodiment, the first user equipment obtains the vector σ_{B} according to the long-term private key s_{B} and the temporary private key y_{B} that correspond to the first user equipment and the received long-term public key P_{A} and temporary public key x_{A} that correspond to the second user equipment performing session negotiation with the first user equipment, obtains the semaphore v_{B} according to the vector σ_{B} using the randomized function and the cross-rounding function, and obtains the session key K according to the semaphore v_{B} using the modulo-2 rounding function. Because x∈¢_{q} is randomly uniform, the modulo-2 rounding function [x]₂ is uniformly distributed on ¢₂, thereby effectively ensuring security of the session key. In addition, because q is an even number, problems in the other approaches that traffic and calculation costs are increased are further effectively resolved.

The following describes, in detail using several specific embodiments, the technical solution of the method embodiment shown in FIG. 1.

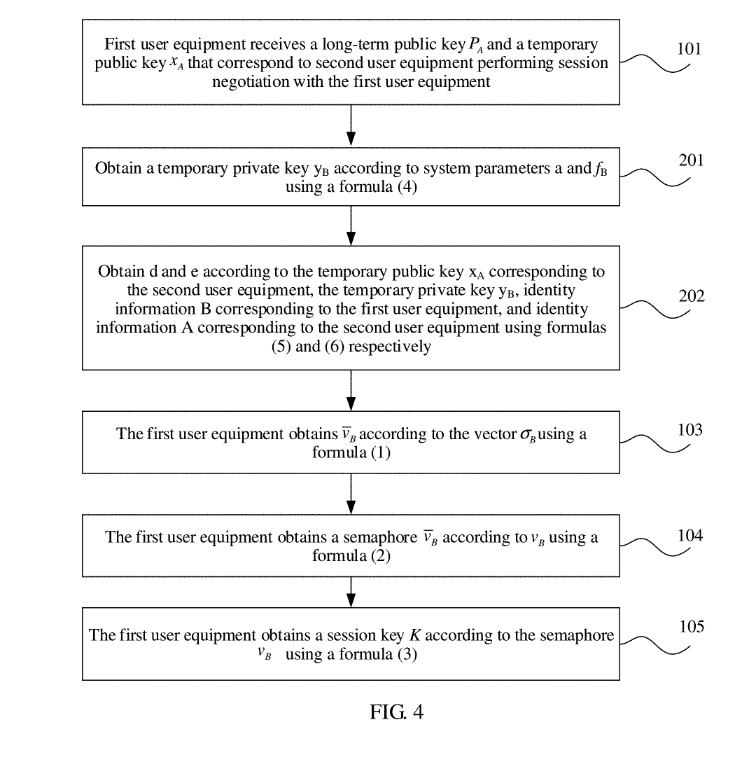

FIG. 4 is a flowchart of Embodiment 2 of a session key negotiation method according to the present disclosure. Based on the embodiment shown in FIG. 3, as shown in FIG. 4, a specific implementation of step 102 is as follows.

Step 201. Perform the following operation according to system parameters a and f_{B} using a formula (4): obtaining the temporary private key y_{B}.

y_{B}=agr_{B}+f_{B}∈R_{q} (4)

Step 202. Perform the following operation according to the temporary public key x_{A} corresponding to the second user equipment, the temporary private key y_{B} corresponding to the first user equipment, identity information B corresponding to the first user equipment, and identity information A corresponding to the second user equipment using formulas (5) and (6): respectively obtaining d and e.

d=H(x_{A},B) (15)

e=H(y_{B},A) (16)

In this embodiment, each of the identity information A and the identity information B may represent a bit string that is coded as 0 and 1 by an authentication center, such as an identity card number or fingerprint information.

Step 203. Perform the following operation according to the long-term private key s_{B} and the temporary private key r_{B} that correspond to the first user equipment, the long-term public key P_{A} and the temporary public key x_{A} that correspond to the second user equipment, d, and e using a formula (7): obtaining σ_{B}.

σ_{B}=gg(x_{A}+dgP_{A})g(r_{B}+egs_{B})∈R_{q} (7)

Furthermore, a∈R_{q}=¢_{q}[ζₘ], r_{B}←χ, f_{B}←χ, g is a system parameter, and g∈R, R is a cyclotomic ring, and R_{q} is a quotient ring defined on

$$R = ¢ [ {ζ}_{m} ] = \frac{¢ [ x ]}{{Φ}_{m} ( x )} .$$

In addition, m is a positive integer, and describes a regulation of the m-order cyclotomic ring

$$R = ¢ [ {ζ}_{m} ] = \frac{¢ [ x ]}{{Φ}_{m} ( x )} ,$$

and a degree of Φₘ(x) and n=φ(m). gcd(q,m)=1, g=Πₚ(1−ζₚ), and p traverses all odd primes that can be exactly divided by m. [ψ] is discrete Gaussian distribution on an algebraic number field K, and

$$ψ = {D}_{\sqrt{2} r} .$$

H(·):{0,1}*→R represents that any string is mapped to an element that satisfies the discrete Gaussian distribution χ=[ψ] and that is located on R=¢[ζₘ]. a∈R_{q}=¢_{q}[ζₘ] represents a global public parameter.

In this embodiment, in a case of a general cyclotomic polynomial ring, a decoding basis (a dual of a conjugate of a powerful basis) is used to represent an element on a ring R and is used for calculation such that a relatively small element representation and calculation cost can be obtained.

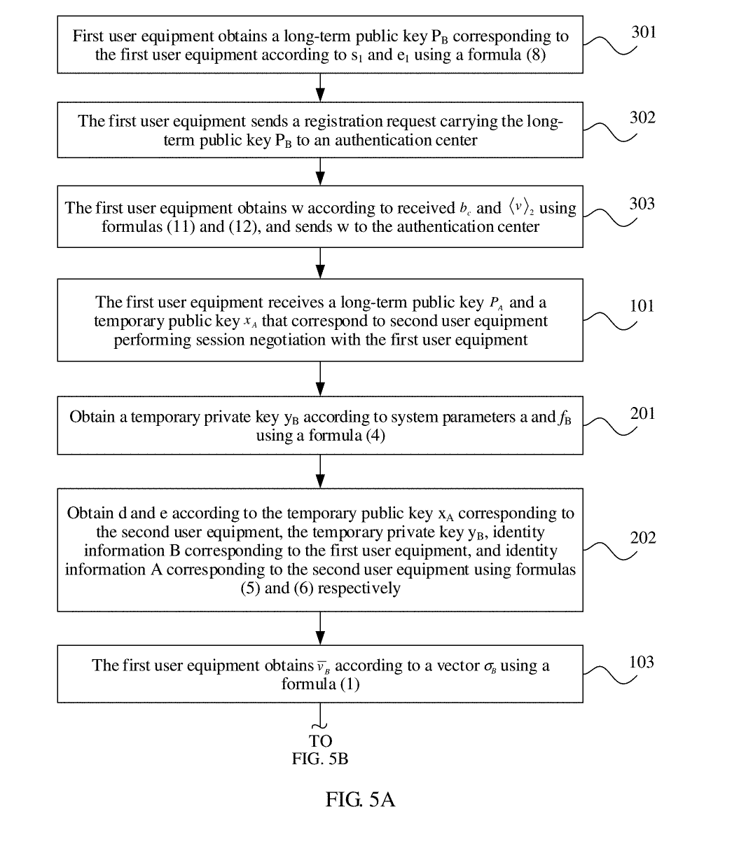

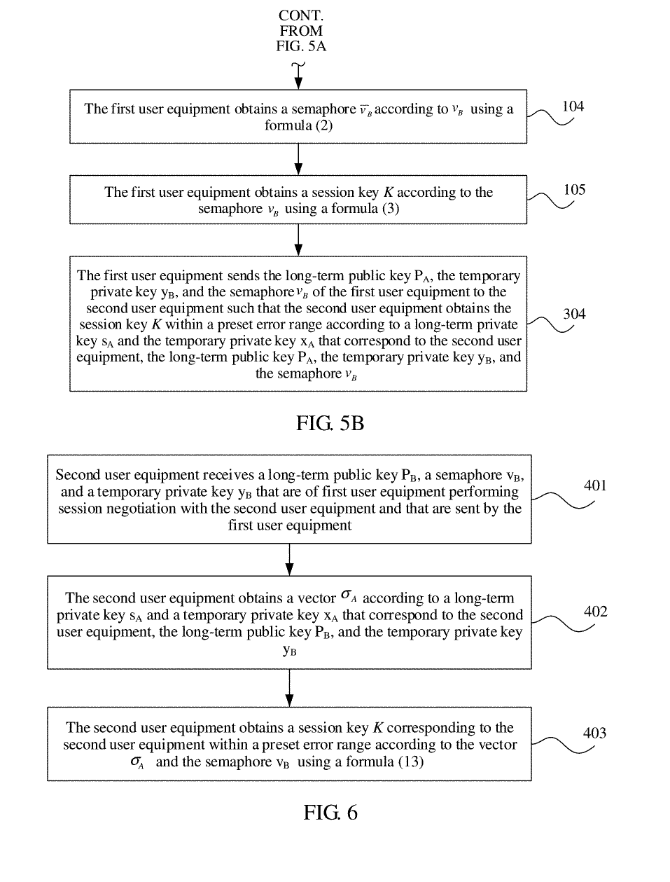

FIG. 5A and FIG. 5B are flowcharts of Embodiment 3 of a session key negotiation method according to the present disclosure. Based on the embodiment shown in FIG. 4, as shown in FIG. 5A and FIG. 5B, before step 101, the method may further include the following steps.

Step 301. The first user equipment performs the following operation according to s₁ and e₁ using a formula (8): obtaining a long-term public key P_{B} corresponding to the first user equipment.

P_{B}=ags₁+e₁∈R_{q} (8)

Step 302. The first user equipment sends a registration request carrying the long-term public key P_{B} to the authentication center such that when authenticating, according to the registration request, that the long-term public key P_{B}≠0, the authentication center performs the following operations according to s, e, and e′ using formulas (9) and (10): obtaining b_{c}, [v]₂, and [symbol] v [symbol] ₂, and returning b_{c} and [symbol] v [symbol] ₂ to the first user equipment.

b_{c}=ags+e (9)

v=ggbgs+e′ (10)

Step 303. The first user equipment performs the following operations according to the received b_{c} and [symbol] v [symbol] ₂ using formulas (11) and (12): obtaining w, and sending w to the authentication center such that when authenticating that w=[v]₂, the authentication center sends a first certificate Cert_{B} to the first user equipment, to certify that the first user equipment owns the long-term public key P_{B}.

u=ggb_{c}gs₁ (11)

w=rec(u, [symbol] v [symbol] ₂) (12)

s₁, e₁←χ, s, e, and e′←χ.

Because long-term public keys of two user equipments performing negotiation can be authenticated, it is ensured that the second user equipment determines that it is the first user equipment that performs key negotiation with the second user equipment, thereby ensuring security of key negotiation.

Still further, after step 105, the method may further include the following step.

Step 304. The first user equipment sends the long-term public key P_{B}, the temporary private key y_{B}, and the semaphore v_{B} of the first user equipment to the second user equipment such that the second user equipment obtains the session key K within a preset error range according to a long-term private key s_{A} and the temporary private key r_{A} that correspond to the second user equipment, the long-term public key P_{B}, the temporary private key y_{B}, and the semaphore v_{B}.

The preset error range is

$$[ - \frac{q}{8} , \frac{q}{8} ) .$$

FIG. 6 is a flowchart of Embodiment 4 of a session key negotiation method according to the present disclosure. As shown in FIG. 6, the method in this embodiment includes the following steps.

Step 401. Second user equipment receives a long-term public key P_{B}, a semaphore v_{B}, and a temporary private key y_{B} that are of first user equipment performing session negotiation with the second user equipment and that are sent by the first user equipment.

In this embodiment, session key negotiation between the first user equipment and the second user equipment is performed in a distributed network environment. The first user equipment may perform the technical solution of the method shown in any one of FIG. 1 to FIG. 3. Implementation principles thereof are similar, and details are not described herein again.

Step 402. The second user equipment obtains a vector σ_{A} according to a long-term private key s_{A} and a temporary private key x_{A} that correspond to the second user equipment, the long-term public key P_{B}, and the temporary private key y_{B}.

Step 403. The second user equipment performs the following operation within a preset error range according to the vector σ_{A} and the semaphore v_{B} using a formula (13): obtaining a session key K corresponding to the second user equipment.

K=rec(σ_{A},v_{B}) (13)

The preset error range is

$$[ - \frac{q}{8} , \frac{q}{8} ) ,$$

and q is an even number and is not equal to 2.

In this embodiment, the first user equipment participating in the key negotiation publicly transmits the long-term public key P_{B}, the semaphore v_{B}, and the temporary private key y_{B}, and the second user equipment participating in the key negotiation receives the long-term public key P_{B}, the semaphore v_{B}, and the temporary private key y_{B}, and obtains the session key K corresponding to the second user equipment using the formula K=rec(σ_{A},v_{B}) according to the vector σ_{A} calculated and obtained according to its own long-term private key s_{A} and temporary private key x_{A} such that two parties of the key negotiation obtain the key K that is evenly distributed on {0,1} in terms of information theory, thereby ensuring security of the session key. In addition, because q is an even number, the problems in the other approaches that traffic and calculation costs are increased are further effectively resolved.

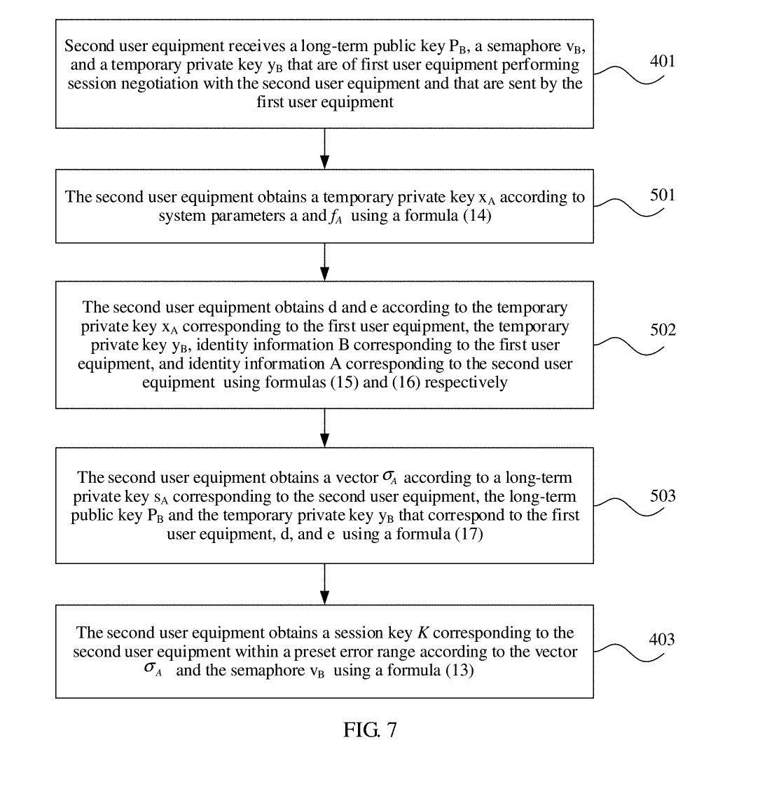

FIG. 7 is a flowchart of Embodiment 5 of a session key negotiation method according to the present disclosure. Based on the embodiment shown in FIG. 6, as shown in FIG. 7, a specific implementation of step 402 is as follows.

Step 501. The second user equipment performs the following operation according to system parameters a and f_{A} using a formula (14): obtaining the temporary public key x_{A}.

x_{A}=agr_{A}+f_{A}∈R_{q} (14)

Step 502. The second user equipment performs the following operation according to the temporary private key x_{A} corresponding to the first user equipment, the temporary private key y_{B}, identity information B corresponding to the first user equipment, and identity information A corresponding to the second user equipment using formulas (15) and (16): respectively obtaining d and e.

d=H(x_{A},B) (15)

e=H(y_{B},A) (16)

Step 503. The second user equipment performs the following operation according to the long-term private key s_{A} corresponding to the second user equipment, the long-term public key P_{B} and the temporary private key y_{B} that correspond to the first user equipment, d, and e using a formula (17): obtaining the vector σ_{A}.

σ_{A}=gg(y_{B}+dgP_{B})g(r_{A}+egs_{A})∈R_{q} (17)

Furthermore a∈R_{q}=¢_{q}[ζₘ], r_{A}←χ, f_{A}←χ, g is a system parameter, and g∈R, R is a cyclotomic ring, and R_{q} is a quotient ring defined on

$$R = ¢ [ {ζ}_{m} ] = \frac{¢ [ x ]}{Φ ( x )} ,$$

and m is a positive integer.

In this embodiment, in a case of a general cyclotomic polynomial ring, a decoding basis (a dual of a conjugate of a powerful basis) is used to represent an element on a ring R and is used for calculation such that a relatively small element representation and calculation cost can be obtained.

FIG. 8 is a flowchart of Embodiment 6 of a session key negotiation method according to the present disclosure. Based on the embodiment shown in FIG. 7, as shown in FIG. 8, the method may further include the following steps.

Step 601. The second user equipment performs the following operation according to s₁ and e₁ using a formula (18): obtaining a long-term public key P_{A} corresponding to the second user equipment.

P_{A}=ags₁+e₁∈R_{q} (18)

Step 602. The second user equipment sends a registration request carrying the long-term public key P_{A} to an authentication center such that when authenticating, according to the registration request, that P_{A}≠0, the authentication center performs the following operations according to s, e, and e′ using formulas (19) and (20) obtaining b_{c}, [v]₂, and [symbol] v [symbol] ₂, and returning b_{c} and [symbol] v [symbol] ₂ to the second user equipment.

b_{c}=ags+e (19)

v=ggbgs+e′ (20)

Step 603. The second user equipment performs the following operation according to the received b_{c} and [symbol] v [symbol] ₂ using formulas (21) and (22): obtaining w, and sending w to the authentication center such that when authenticating that w=[v]₂, the authentication center sends a second certificate Cert_{A} to the second user equipment, to certify that the second user equipment owns the long-term public key P_{A}.

u=ggb_{c}gs₁ (21)

w=rec(u, [symbol] v [symbol] ₂) (22)

Further, s₁, e₁←χ, s, e, and e′←χ.

In this embodiment, because long-term public keys of two user equipments performing negotiation can be authenticated, it is ensured that the first user equipment determines that it is the second user equipment that performs key negotiation with the first user equipment, thereby ensuring security of key negotiation.

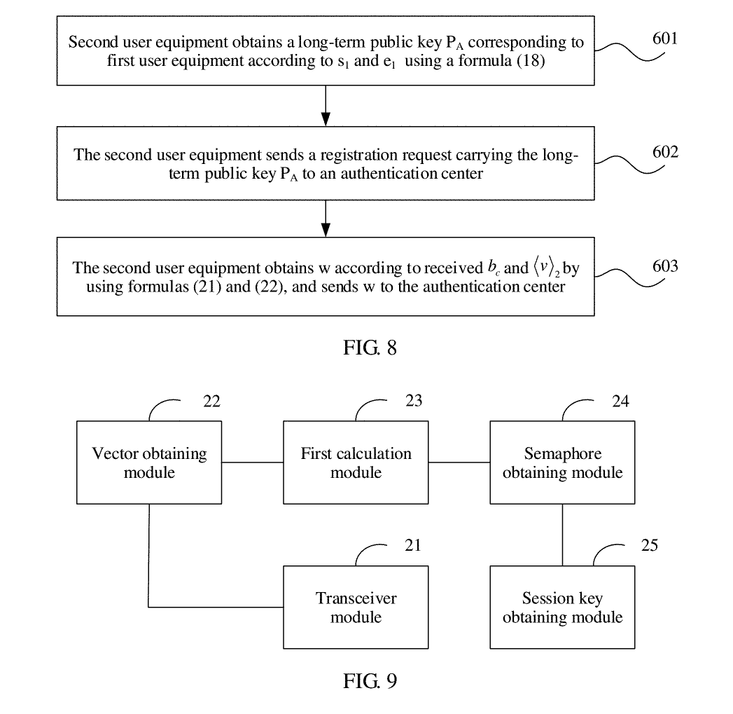

FIG. 9 is a schematic structural diagram of Embodiment 1 of a session key negotiation apparatus according to the present disclosure. As shown in FIG. 9, the apparatus in this embodiment may include a transceiver module 21, a vector obtaining module 22, a first calculation module 23, a semaphore obtaining module 24, and a session key obtaining module 25. The transceiver module 21 is configured to receive a long-term public key P_{A} and a temporary public key x_{A} that correspond to second user equipment performing session negotiation with the session key negotiation apparatus. The vector obtaining module 22 is configured to obtain a vector σ_{B} according to a long-term private key s_{B} and a temporary private key y_{B} that correspond to the session key negotiation apparatus, the long-term public key P_{A}, and the temporary public key x_{A}. The first calculation module 23 is configured to obtain v̅_{B} according to the vector σ_{B} using a formula v̅_{b}=dbl(σ_{B}). The semaphore obtaining module 24 is configured to obtain a semaphore v_{B} according to v̅_{B} according to v_{B}= [symbol] v̅_{B} [symbol] ₂. The session key obtaining module 25 is configured to obtain a session key K according to the semaphore v_{B} using a formula

$$K = {[ {\overline{v}}_{B} ]}_{2} = [ \frac{2}{q} g {\overline{v}}_{B} ] ,$$

where q is an even number and is not equal to 2.

The apparatus in this embodiment may be the first user equipment, and is configured to perform the technical solution of the method embodiment shown in FIG. 1. Implementation principles and technical effects thereof are similar, and details are not described herein again.

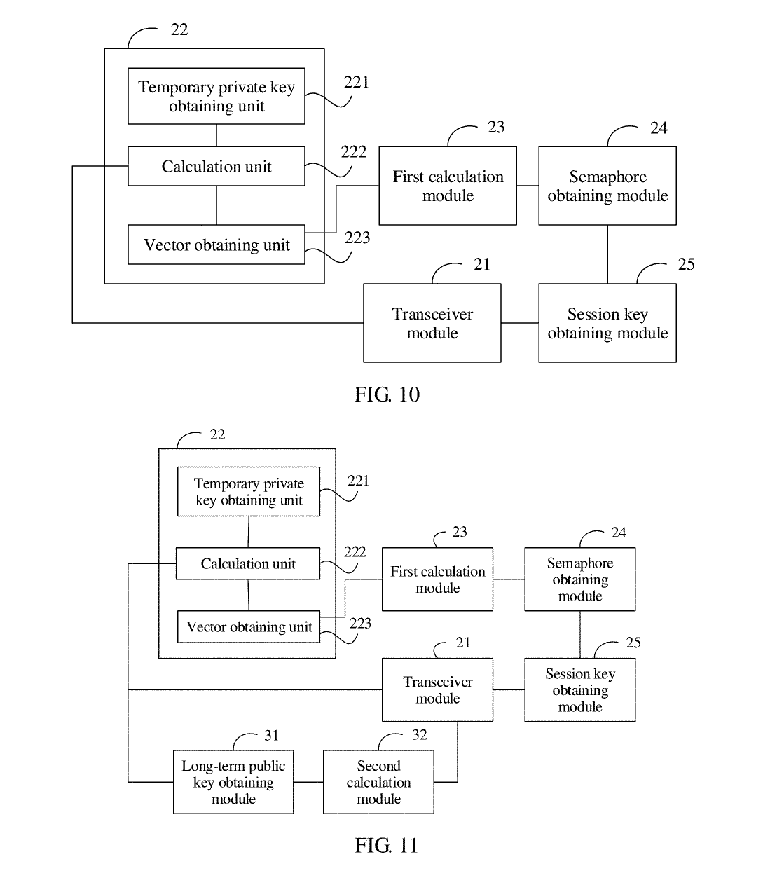

FIG. 10 is a schematic structural diagram of Embodiment 2 of a session key negotiation apparatus according to the present disclosure. As shown in FIG. 10, based on the structure of the apparatus shown in FIG. 9, in the apparatus in this embodiment, further, the vector obtaining module 22 further includes a temporary private key obtaining unit 221, a calculation unit 222, and a vector obtaining unit 223. The temporary private key obtaining unit 221 is configured to obtain the temporary private key y_{B} according to system parameters a and f_{B} using a formula y_{B}=agr_{B}+f_{B}∈R_{q}. The calculation unit 222 is configured to obtain d and e according to the temporary public key x_{A} corresponding to the second user equipment, the temporary private key y_{B} corresponding to the session key negotiation apparatus, identity information B corresponding to the session key negotiation apparatus, and identity information A corresponding to the second user equipment using formulas d=H(x_{A},B) and e=H(y_{B},A) respectively. The vector obtaining unit 223 is configured to obtain σ_{B} according to the long-term private key s_{B} and the temporary private key r_{B} that correspond to the session key negotiation apparatus, the long-term public key P_{A} and the temporary public key x_{A} that correspond to the second user equipment, d, and e using a formula σ_{B}=gg(x_{A}+dgP_{A})g(r_{B}+egs_{B})∈R_{q}.

a∈R_{q}=¢_{q}[ζₘ], r_{B}←χ, f_{B}←χ, g is a system parameter, and g∈R, R is a cyclotomic ring, and R_{q} is a quotient ring defined on

$$R = ¢ [ {ζ}_{m} ] = \frac{¢ [ x ]}{{Φ}_{m} ( x )} ,$$

and m is a positive integer.

The apparatus in this embodiment may be configured to perform the technical solution of the method embodiment shown in FIG. 2. Implementation principles and technical effects thereof are similar, and details are not described herein again.

FIG. 11 is a schematic structural diagram of Embodiment 3 of a session key negotiation apparatus according to the present disclosure. As shown in FIG. 11, based on the structure of the apparatus shown in FIG. 10, further, the apparatus in this embodiment may further include a long-term public key obtaining module 31 and a second calculation module 32. The long-term public key obtaining module 31 is configured to obtain a long-term public key P_{B} corresponding to the session key negotiation apparatus according to s₁ and e₁ using a formula P_{B}32 ags₁+e₁∈R_{q}. The transceiver module 21 is further configured to send a registration request carrying the long-term public key P_{B} to an authentication center such that when authenticating the long-term public key P_{B} according to the registration request, the authentication center obtains b_{c}, [symbol] v [symbol] ₂, according to s, e, and e′ using formulas b_{c}=ags+e and v=ggbgs+e′, and returns b_{c} and [symbol] v [symbol] ₂ to the session key negotiation apparatus. The second calculation module 32 is configured to obtain w according to the received b_{c} and [symbol] v [symbol] ₂ formulas u=ggb_{c}gs₁ and w=rec(u, [symbol] v [symbol] ₂). The transceiver module 21 is further configured to send w to the authentication center such that when authenticating that w=[v]₂, the authentication center sends a first certificate Cert_{B} to the session key negotiation apparatus, to certify that the session key negotiation apparatus owns the long-term public key P_{B}, where s₁, e₁←χ, s, e, e′←χ.

Further, the transceiver module 21 is further configured to send the long-term public key P_{B}, the temporary private key y_{B}, and the semaphore v_{B} of the session key negotiation apparatus to the second user equipment such that the second user equipment obtains the session key K within a preset error range according to a long-term private key s_{A} and the temporary private key r_{A} that correspond to the second user equipment, the long-term public key P_{B}, the temporary private key y_{B}, and the semaphore v_{B}.

The preset error range is

$$[ - \frac{q}{8} , \frac{q}{8} ) .$$

The apparatus in this embodiment may be configured to perform the technical solution of the method embodiment shown in FIG. 3. Implementation principles and technical effects thereof are similar, and details are not described herein again.

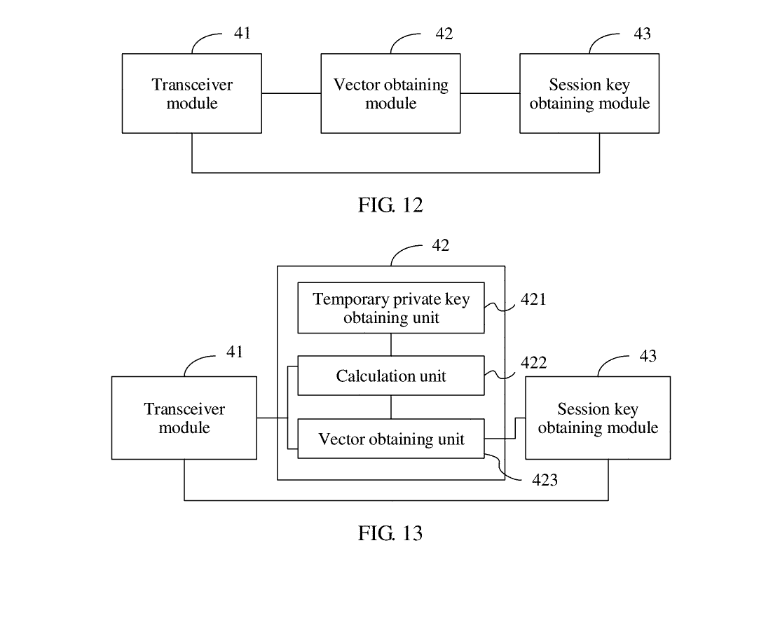

FIG. 12 is a schematic structural diagram of Embodiment 4 of a session key negotiation apparatus according to the present disclosure. As shown in FIG. 12, the apparatus includes a transceiver module 41, a vector obtaining module 42, and a session key obtaining module 43. The transceiver module 41 is configured to receive a long-term public key P_{B}, a semaphore v_{B}, and a temporary private key y_{B} that are of first user equipment performing session negotiation with the session key negotiation apparatus and that are sent by the first user equipment. The vector obtaining module 42 is configured to calculate and obtain a vector σ_{A} according to a long-term private key s_{A} and a temporary private key x_{A} that correspond to the session key negotiation apparatus, the long-term public key P_{B}, and the temporary private key y_{B}. The session key obtaining module 43 is configured to obtain a session key K corresponding to the session key negotiation apparatus within a preset error range according to the vector σ_{A} and the semaphore v_{B} using a formula K=rec(σ_{A},v_{B}).

The preset error range is

$$[ - \frac{q}{8} , \frac{q}{8} ) ,$$

and q is an even number and is not equal to 2.

The apparatus in this embodiment may be the second user equipment, and is configured to perform the technical solution of the method embodiment shown in FIG. 6. Implementation principles and technical effects thereof are similar, and details are not described herein again.

FIG. 13 is a schematic structural diagram of Embodiment 5 of a session key negotiation apparatus according to the present disclosure. As shown in FIG. 13, based on the structure of the apparatus shown in FIG. 12, the vector obtaining module 42 includes a temporary private key obtaining unit 421, a calculation unit 422, and a vector obtaining unit 423. The temporary private key obtaining unit 421 is configured to obtain a temporary public x_{A} according to system parameters a and f_{A} using a formula x_{A}=agr_{A}+f_{A}∈R_{q}. The calculation unit 422 is configured to obtain d and e according to the temporary public key x_{A} corresponding to the first user equipment, the temporary private key y_{B}, identity information B corresponding to the first user equipment, and identity information A corresponding to the session key negotiation apparatus using formulas d=H(x_{A},B) and e=H(y_{B},A) respectively. The vector obtaining unit 423 is configured to obtain the vector σ_{A} according to the long-term private key s_{A} corresponding to the session key negotiation apparatus, the long-term public key P_{B} and the temporary private key y_{B} that correspond to the first user equipment, d, and e using a formula σ_{A}=gg(y_{B}+dgP_{B})g(r_{A}+egs_{A})∈R_{q}, where a∈R_{q}=¢_{q}[ζₘ], r_{A}←χ, f_{A}=χ, g is a system parameter, and g∈R, R is a cyclotomic ring, and R_{q} is a quotient ring defined on

$$R = ¢ [ {ζ}_{m} ] = \frac{¢ [ x ]}{Φ ( x )} ,$$

and m is a positive integer.

The apparatus in this embodiment may be configured to perform the technical solution of the method embodiment shown in FIG. 7. Implementation principles and technical effects thereof are similar, and details are not described herein again.

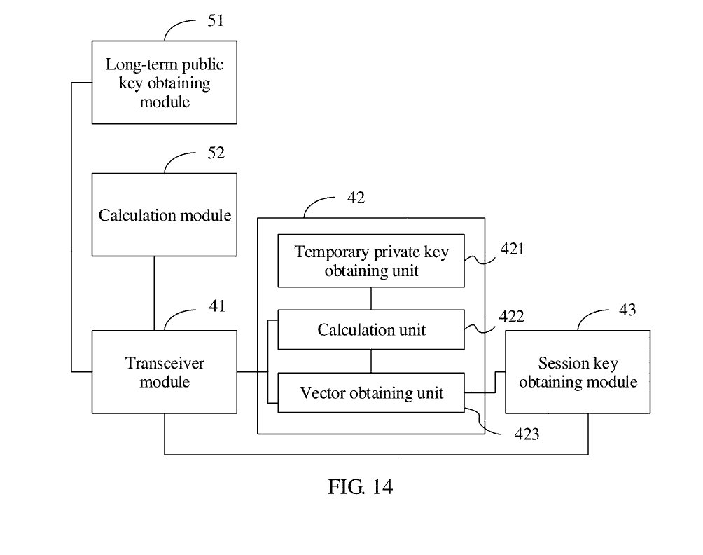

FIG. 14 is a schematic structural diagram of Embodiment 6 of a session key negotiation apparatus according to the present disclosure. As shown in FIG. 14, based on the embodiment shown in FIG. 13, further, the apparatus may further include a long-term public key obtaining module 51 and a calculation module 52. The long-term public key obtaining module 51 is configured to obtain a long-term public key P_{A} corresponding to the second user equipment according to s₁ and e₁ using a formula P_{A}=ags₁+e₁∈R_{q}. The transceiver module 41 is further configured to send a registration request carrying the long-term public key P_{A} to an authentication center such that when authenticating, according to the registration request, that P_{A}≠0, the authentication center obtains b_{c}, [v]₂, and [symbol] v [symbol] ₂ according to s, e, and e′ using formulas b_{c}=ags+e and v=ggbgs+e′, and returns b_{c} and [symbol] v [symbol] ₂ to the session key negotiation apparatus. The calculation module 52 is configured to obtain w according to the received b_{c} and [symbol] v [symbol] ₂ using formulas u=ggb_{c}gs₁ and w=rec(u, [symbol] v [symbol] ₂). The transceiver module 41 is further configured to send w to the authentication center such that when authenticating that w=[v]₂, the authentication center sends a second certificate Cert_{A} to the session key negotiation apparatus, to certify that the session key negotiation apparatus owns the long-term public key P_{A}, where s₁, e₁←χ, s, e, e′←χ.

The apparatus in this embodiment may be configured to perform the technical solution of the method embodiment shown in FIG. 8. Implementation principles and technical effects thereof are similar, and details are not described herein again.

The present disclosure further provides a session key negotiation system. The system includes first user equipment and second user equipment that performs session negotiation with the first user equipment. The first user equipment is configured to perform the technical solutions of the method embodiment shown in any one of FIG. 1 to FIG. 3, and the second user equipment is configured to implement the technical solutions of the method embodiment shown in any one of FIG. 6 to FIG. 8. Implementation principles and technical effects thereof are similar, and details are not described herein again.

The present disclosure further provides a session key negotiation apparatus. The apparatus includes a processor, a memory, and a communications interface. The memory is configured to store executable program code. The processor reads the executable program code stored in the memory, to run a program corresponding to the executable program code.

The communications interface receives a long-term public key P_{A} and a temporary public key x_{A} that correspond to second user equipment performing session negotiation with the session key negotiation apparatus.

The processor obtains a vector σ_{B} according to a long-term private key s_{B} and a temporary private key y_{B} that correspond to the session key negotiation apparatus, the long-term public key P_{A}, and the temporary public key x_{A}, obtains v̅_{B} according to the vector σ_{B} using the formula v̅_{B}=dbl/(σ_{B}), obtains a semaphore v_{B} according to v̅_{B} using a formula v_{B}= [symbol] v̅_{B} [symbol] ₂, and obtains a session key K according to the semaphore v_{B} using the formula

$$K = {[ {\overline{v}}_{B} ]}_{2} = [ \frac{2}{q} g {\overline{v}}_{B} ] ,$$

where q is an even number and is not equal to 2.

In this embodiment, the session key negotiation apparatus is the first user equipment, and is configured to perform the technical solution of the method embodiment shown in any one of FIG. 1 to FIG. 3. Implementation principles and technical effects thereof are similar, and details are not described herein again.

The present disclosure further provides a session key negotiation apparatus. The apparatus includes a processor, a memory, and a communications interface. The memory is configured to store executable program code. The processor reads the executable program code stored in the memory, to run a program corresponding to the executable program code.

The communications interface receives a long-term public key P_{B}, a semaphore v_{B}, and a temporary private key y_{B} that are of first user equipment performing session negotiation with the session key negotiation apparatus and that are sent by the first user equipment.

The processor obtains a vector σ_{A} according to a long-term private key s_{A} and a temporary private key x_{A} that correspond to the session key negotiation apparatus, the long-term public key P_{B}, and the temporary private key y_{B}, and obtains a session key K corresponding to the session key negotiation apparatus within a preset error range according to the vector σ_{A} and the semaphore v_{B} using a formula K=rec(σ_{A},v_{B}), where the preset error range is

$$[ - \frac{q}{8} , \frac{q}{8} ) ,$$

and q is an even number and is not equal to 2.

In this embodiment, the session key negotiation apparatus is the second user equipment, and is configured to perform the technical solution of the method embodiment shown in any one of FIG. 6 to FIG. 8. Implementation principles and technical effects thereof are similar, and details are not described herein again.

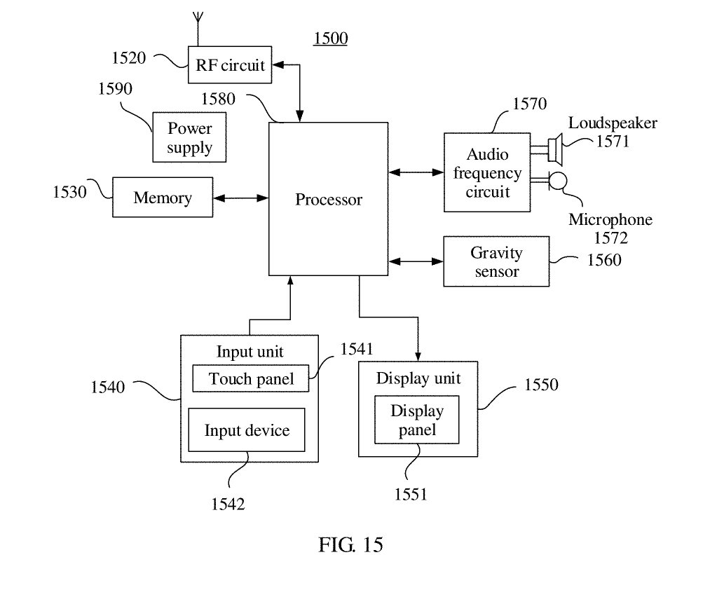

FIG. 15 is a schematic structural diagram of user equipment according to an embodiment of the present disclosure. The user equipment provided in this embodiment of the present disclosure may be configured to implement the methods implemented in the embodiments of the present disclosure that are shown in FIG. 3 to FIG. 8. For ease of description, only a part related to this embodiment of the present disclosure is shown. For specific technical details that are not disclosed, refer to the embodiments of the present disclosure that are shown in FIG. 3 to FIG. 8.

The user equipment may be a terminal device, such as a mobile phone, a tablet computer, a notebook computer, a ultra-mobile personal computer (UMPC), a netbook, or a personal digital assistant (PDA). This embodiment of the present disclosure is described using an example in which the user equipment is a mobile phone. FIG. 15 is a block diagram of a part of a structure of a mobile phone 1500 related to the embodiments of the present disclosure.

As shown in FIG. 15, the mobile phone 1500 includes a radio frequency (RF) circuit 1520, a memory 1530, an input unit 1540, a display unit 1550, a gravity sensor 1560, an audio frequency circuit 1570, a processor 1580, a power supply 1590, and the like. Persons skilled in the art may understand that the structure of the mobile phone shown in FIG. 15 does not constitute a limitation to the mobile phone. The mobile phone may include more or fewer components than those shown in the figure, or combine some components, or have a different component arrangement.

The following further describes, with reference to FIG. 15, the components included in the mobile phone 1500.

The RF circuit 1520 may be configured to receive and send signals during an information receiving and sending process or a call process. Particularly, the RF circuit 1520 receives downlink information from a base station, then sends the downlink information to the processor 1580 for processing, and sends uplink data to the base station. Generally, the RF circuit includes but is not limited to an antenna, at least one amplifier, a transceiver, a coupler, a low noise amplifier (LNA), and a duplexer. In addition, the RF circuit 1520 may further communicate with a network and another device by means of wireless communication. The wireless communication may comply with any communication standard or protocol, including but not limited to Global System for Mobile Communications (GSM), General Packet Radio Service (GPRS), Code Division Multiple Access (CDMA), Wideband CDMA (WCDMA), Long Term Evolution (LTE), e-mail, and short messaging service (SMS).

The memory 1530 may be configured to store a software program and a module, and the processor 1580 runs the software program and the module that are stored in the memory 1530, to perform various function applications and data processing of the mobile phone 1500. The memory 1530 may mainly include a program storage area and a data storage area. The program storage area may store an operating system, an application required by at least one function (such as a sound playback function and an image play function), and the like. The data storage area may store data (such as audio data, image data, and an address book) created according to use of the mobile phone 1500. In addition, the memory 1530 may include a high-speed random access memory, and may further include a non-volatile memory, for example, at least one magnetic disk storage device, a flash memory, or another volatile solid state storage device.

The input unit 1540 may be configured to receive input digit or character information, and generate keyboard signal input related to user settings and function control of the mobile phone 1500 Further, the input unit 1540 may include a touchscreen 1541 and an input device 1542. The touchscreen 1541, also referred to as a touch panel, may collect a touch operation (such as an operation of a user on or near the touchscreen 1541 using any suitable object or accessory such as a finger or a stylus) of a user on or near the touchscreen, and drive a corresponding connection apparatus according to a preset program. Optionally, the touchscreen 1541 may include a touch detection apparatus and a touch controller. The touch detection apparatus detects a touch position of the user, detects a signal generated by the touch operation, and sends the signal to the touch controller. The touch controller receives touch information from the touch detection apparatus, converts the touch information into touch point coordinates, and sends the touch point coordinates to the processor 1580. Moreover, the touch controller can receive a command from the processor 1580, and executes the command. In addition, the touchscreen 1541 may be a resistive touchscreen, a capacitive touchscreen, an infrared touchscreen, a surface wave sound touchscreen, or the like. In addition to the touchscreen 1541, the input unit 1540 may further include the input device 1542. Further, the input device 1542 may include but is not limited to one or more of a physical keyboard, a function key (such as a volume control key or a power switch key), a track ball, a mouse, or a joystick.

The display unit 1550 may be configured to display information entered by the user or information provided for the user, and various menus of the mobile phone 1500. The display unit 1550 may include a display panel 1551. Optionally, the display panel 1551 may be configured using a liquid crystal display (LCD), an organic light-emitting diode (OLED), or the like. Further, the 1541 may cover the display panel 1551. After detecting a touch operation on or near the touchscreen 1541, the touchscreen 1541 sends the touch operation to the processor 580, to determine a type of a touch event. Then, the processor 1580 provides corresponding visual output on the display panel 1551 according to the type of the touch event. Although in FIG. 15, the touchscreen 1541 and the display panel 1551 are used as two independent components to implement input and output functions of the mobile phone 1500, in some embodiments, the touchscreen 1541 and the display panel 1551 may be integrated to implement the input and output functions of the mobile phone 1500.

The gravity sensor 1560 may detect magnitude of acceleration of the mobile phone in various directions (generally on three axes), may detect magnitude and a direction of gravity when static, and may be applied to an application that recognizes an attitude (for example, switching between landscape orientation and portrait orientation, a related game, and magnetometer attitude calibration) of the mobile phone, a function related to vibration recognition (such as a pedometer and a knock), and the like.

The mobile phone 1500 may include another sensor, for example, an optical sensor. Further, the optical sensor may include an ambient light sensor and an optical proximity sensor. The ambient light sensor may adjust luminance of the display panel 1541 according to brightness of the ambient light. The optical proximity sensor may detect whether an object approaches or touches the mobile phone, and may switch off the display panel 1541 and/or backlight when the mobile phone 1500 is moved to the ear. Another sensor, such as a gyroscope, a barometer, a hygrometer, a thermometer, or an infrared sensor, may be configured in the mobile phone 1500, and details are not described herein again.

The audio frequency circuit 1570, a loudspeaker 1571, and a microphone 1572 may provide an audio interface between the user and the mobile phone 1500. The audio frequency circuit 1570 may convert received audio data into an electrical signal, and transmits the electrical signal to the loudspeaker 1571. The loudspeaker converts the electrical signal into a sound signal and outputs the sound signal. In another aspect, the microphone 1572 converts a collected sound signal into an electrical signal, the audio frequency circuit 1570 receives the electrical signal and converts the electrical signal into audio data, and outputs the audio data to the RF circuit 1520 such that the RF circuit 1520 sends the audio data to another mobile phone, or transmits the audio data to the memory 1530 for further processing.

The processor 1580 is a control center of the mobile phone 1500, connects all parts of the mobile phone using various interfaces and lines, and performs various functions of the mobile phone 1500 and processes data by running or performing the software program and/or the module that are/is stored in the memory 1530 and invoking data stored in the memory 1530, to perform overall monitoring on the mobile phone. Optionally, the processor 1580 may include one or more processing units. Preferably, the processor 1580 may integrate an application processor and a modem processor. The application processor mainly processes an operating system, a user interface, an application program, and the like. The modem processor mainly processes radio communication. It may be understood that the modem processor may not be integrated into the processor 1580.

The mobile phone 1500 further includes a power supply 1590 (for example, a battery) that supplies power to the components. Preferably, the power supply may connect to the processor 1580 logically using a power management system, to manage functions such as charging, discharging, and power consumption management using the power management system.

Although not shown, the mobile phone 1500 may further include a WI-FI module, a BLUETOOTH module, and the like. Details are not described herein.

In this embodiment of the present disclosure, the memory 1530 is further configured to store executable program code. The input unit 1540 is further configured to receive a long-term public key P_{A} and a temporary public key x_{A} that correspond to second user equipment performing session negotiation with the session key negotiation apparatus. The processor 1580 is further configured to obtain a vector σ_{B} according to a long-term private key s_{B} and a temporary private key y_{B} that correspond to the session key negotiation apparatus, the long-term public key P_{A}, and the temporary public key x_{A}, obtain v̅_{B} according to the vector σ_{B} using a formula v̅_{B}=dbl(σ_{B}), obtain a semaphore v_{B} according to v̅_{B} using a formula v_{B}= [symbol] v̅ [symbol] ₂, and obtain a session key K according to the semaphore v_{B} using a formula

$$K = {[ {\overline{v}}_{B} ]}_{2} = [ \frac{2}{q} g {\overline{v}}_{B} ] ,$$

where q is an even number and is not equal to 2.

Alternatively, in this embodiment of the present disclosure, the memory 1530 is further configured to store executable program code. The input unit 1540 is further configured to receive a long-term public key P_{B}, a semaphore v_{B}, and a temporary private key y_{B} that are of first user equipment performing session negotiation with the session key negotiation apparatus and that are sent by the first user equipment. The processor 1580 is further configured to obtain a vector σ_{A} according to a long-term private key s_{A} and a temporary private key x_{A} that correspond to the session key negotiation apparatus, the long-term public key P_{B}, and the temporary private key y_{B}, and obtain a session key K corresponding to the session key negotiation apparatus within a preset error range according to the vector σ_{A} and the semaphore v_{B} using a formula K=rec(σ_{A},v_{B}), where the preset error range is

$$[ - \frac{q}{8} , \frac{q}{8} ) ,$$

and q is an even number and is not equal to 2.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes any medium that can store program code, such as a read-only memory (ROM), a random access memory (RAM), a magnetic disk, or an optical disc.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

1. A session key negotiation method, comprising:
receiving, by a first user equipment, a long-term public key (P_{A}) and a temporary public key (x_{A}) corresponding to a second user equipment that performs a session negotiation with the first user equipment;
obtaining, by the first user equipment, a vector (σ_{B}) according to a long-term private key (s_{B}) and a temporary private key (r_{B}) that correspond to the first user equipment, the P_{A}, and the x_{A};
obtaining, by the first user equipment, a v̅_{B} according to the σ_{B} using a formula v̅_{B}=dlb(σ_{B});
obtaining, by the first user equipment, a semaphore (v_{B}) according to the v̅_{B} using a formula v_{B}= [symbol] v̅ [symbol] ₂; and
obtaining, by the first user equipment, a session key (K) according to the v_{B} using a formula
$$K = {[ {\overline{v}}_{B} ]}_{2} = [ \frac{2}{q} g {\overline{v}}_{B} ]$$
to ensure security of the K, the q comprising an even number not equal to two, the g comprising a system paramrter, and the g∈R.

2. The method of claim 1, wherein obtaining the σ_{B} comprises:
obtaining, by the first user equipment, another temporary private key (y_{B}) according to system parameters a and f_{B} using a formula y_{b}=agr_{B}+f_{B}∈R_{q};
obtaining, by the first user equipment, d and e according to the x_{A} corresponding to the second user equipment, the y_{B} corresponding to the first user equipment, identity information corresponding to the first user equipment (B), and identity information corresponding to the second user equipment (A) using formulas d=H(x_{A},B) and e=H(y_{B},A) respectively; and
obtaining, by the first user equipment, the σ_{B} according to the s_{B} and the r_{B} corresponding to the first user equipment, the P_{A} and the x_{A} corresponding to the second user equipment, the d, and the e using a formula σ_{B}=gg(x_{A}+dgP_{A})g(r_{B}+egs_{B})∈R_{q}, the a∈R_{q}=¢_{q}[ζₘ], the r_{B}←χ, the f_{B}←χ, the R comprising a cyclotomic ring, the R_{q} comprising a quotient ring defined on
$$R = ¢ [ {ζ}_{m} ] = \frac{¢ [ x ]}{{Φ}_{m} ( x )} ,$$
and the m comprising a positive integer.

3. The method of claim 1, further comprising:
obtaining, by the first user equipment, another long-term public key (P_{B}) corresponding to the first user equipment according to the s_{B} and e_{B} using a formula P_{B}=ags_{B}+e_{B}∈R_{q};
sending, by the first user equipment, a registration request carrying the P_{B} to an authentication center to authenticate that the P_{B}≠0 such that when authenticating, according to the registration request, that the P_{B}≠0, it is assumed that a primary private key of the authentication centercomprising s_{CA} and a long-term public key comprising P_{CA}=ags_{CA}+e_{CA}, the authentication center selects e′_{CA}, calculates v_{CA}=g·P_{B}·s_{CA}+e′_{CA}, [v_{CA}]₂ and [symbol] v_{CA} [symbol] ₂ according to the s_{CA} of the authentication center and the P_{B} of the first user equipment, sends the P_{CA} and the [symbol] v_{CA} [symbol] ₂ to the first user equipment, and secretly keeps the [v_{CA}]₂ for subsequent authentication;
calculating, by the first user equipment, u_{B}=ggP_{CA}gs_{B} and a string w_{B}=rec(u_{B}, [symbol] v_{CA} [symbol] ₂) according to the received P_{CA} and the [symbol] v_{CA} [symbol] ₂;
obtaining the w_{B}; and
sending the w_{B} to the authentication center to authenticate that the w_{B}=[v_{CA}]₂, the authentication center sends a first certification (Cert_{B}) to the first user equipment to certify that the first user equipment owns the P_{B} when authenticating that the w_{B}=[v_{CA}]₂, the s_{B}, the e_{B}←χ, and the s_{CA}, the e_{CA}, and the e′_{CA}←χ.

4. The method of claim 3, further comprising: sending, by the first user equipment, the P_{B}, the y_{B}, and the v_{B} of the first user equipment to the second user equipment to enable the second user equipment to obtain the K within a preset error range according to another long-term private key (s_{A}) and another temporary private key (r_{A}) corresponding to the second user equipment, the P_{B}, the y_{B}, and the v_{B}, and the preset error range comprising:
$$[ - \frac{q}{8} , \frac{q}{8} ) .$$

5. A session key negotiation method, comprising:
receiving, by a second user equipment, a long-term public key (P_{B}), a semaphore (v_{B}), and a temporary private key (y_{B}) of a first user equipment from the first user equipment, the first user equipment performing a session negotiation with the second user equipment;
obtaining, by the second user equipment, a vector (σ_{A}) according to a long-term private key (s_{A}) and another temporary private key (r_{A}) corresponding to the second user equipment, the P_{B}, and the y_{B}; and
obtaining, by the second user equipment, a session key (K) corresponding to the second user equipment within asreset error range according to the σ_{A} and the v_{B} using a formula K=rec(σ_{A},v_{B}) to ensure security of the K, the preset error range comprising
$$[ - \frac{q}{8} , \frac{q}{8} ) ,$$
and the q comprising an even number not equal to two.

6. The method of claim 5, wherein obtaining the σ_{A} comprises:
obtaining, by the second user equipment, a temporary public key (x_{A}) according to system parameters a and f_{A} using a formula x_{A}=agr_{A}+f_{A}∈R_{q};
obtaining, by the second user equipment, d and e according to the y_{B} corresponding to the first user equipment, the x_{A}, identity information corresponding to the first user equipment (B), and identity information corresponding to the second user equipment (A) using formulas d=H(x_{A},B) and e=H(y_{B},A) respectively; and
obtaining, by the second user equipment, the σ_{A} according to the s_{A} and the r_{A} corresponding to the second user equipment, the P_{B} and the y_{B} corresponding to the first user equipment, the d, and the e using a formula σ_{A}=gg(y_{B}+dgP_{B})g(r_{A}+egs_{A})∈R_{q}, the a∈R_{q}=¢_{q}[ζₘ], the r_{A}←χ, the f_{A}←χ, the g comprising a system, the g∈R, the R comprising a cyclotomic ring, the R_{q} comprising a quotient ring defined on
$$R = ¢ [ {ζ}_{m} ] = \frac{¢ [ x ]}{Φ ( x )} ,$$
and the m comprising a positive integer.

7. The method of claim 6, further comprising:
obtaining, by the second user equipment, a long-term public key (P_{A}) corresponding to the second user equipment according to the s_{A} and e_{A} using a formula P_{A}=ags_{A}+e_{A}∈R_{q};
sending, by the second user equipment, a registration request carrying the P_{A} to an authentication center to authenticate that the P_{A}≠0 such that when authenticating, according to the registration request, that the P_{A}≠0, it is assumed that a primary private key of the authentication center comprising s_{CA} and a long-term pbulic key comprising P_{CA}=ags_{CA}+e_{CA}, the authentication center selects e′_{CA}, calculates v_{CA}=g·P_{A}·s_{CA}+e′_{CA}, [v_{CA}]₂, and [symbol] v_{CA} [symbol] ₂ according to the s_{CA} of the authentication center and the P_{A} of the second user equipment, sends the P_{CA} and the [symbol] v_{CA} [symbol] ₂ to the second user equipment, and secretly keeps the [v_{CA}]₂ for subsequent authentication;
calculating, by the second user equipment, u_{A}=ggP_{CA}gs_{A} and a string w_{A}=rec(u_{A}, [symbol] v_{CA} [symbol] ₂) according to the received P_{CA} and the [symbol] v_{CA} [symbol] ₂;
obtaining w_{A}; and
sending the w_{A} to the authentication center to authenticate that the w_{A}=[v_{CA}]₂ such that when authenticating that the w_{A}=[v_{CA}]₂, the authentication center sends a first certificate (Cert_{A}) to the first user equipment to certify that the first user equipment owns the P_{A}, the s_{A}, the e_{A}←χ, the s_{CA}, the e_{CA}, and the e′_{CA}←χ.

8. A session key negotiation apparatus, comprising:
a transceiver configured to receive a long-term public key (P_{A}) and a temporary public key (x_{A}) corresponding to a second user equipment performing a session negotiation with the session key negotiation apparatus; and
a processor coupled to the transceiver and configured to:
obtain a vector (σ_{B}) according to a long-term private key (s_{B}) and a temporary private key (r_{B}) corresponding to the session key negotiation appartaus, the P_{A}, and the x_{A};
obtain a v̅_{B} according to the σ_{B} using a formula v̅_{B}=dbl(σ_{B});
obtain a semaphore (v_{B}) according to the v̅_{B} using a formula v_{B}= [symbol] v̅_{B} [symbol] ₂; and
obtain a session key (K) according to the v_{B} using a formula
$$K = {[ {\overline{v}}_{B} ]}_{2} = [ \frac{2}{q} g {\overline{v}}_{B} ]$$
to ensure security of the K, the q comprising an even number not equal to two, the g comprising a system parameter, and the g∈R.

9. The apparatus of claim 8, wherein the processor is further configured to:
obtain another temporary private key (y_{B}) according to system parameters a and f_{B} using a formula y_{B}=agr_{B}+f_{B}∈R_{q};
obtain d and e according to the x_{A} corresponding to the second user equipment, the y_{B} corresponding to the session key negotiation apparatus, identity information corresponding to the first user equipment (B), and identity information corresponding to the second user equipment (A) using formulas d=H(x_{A},B) and e=H(y_{B},A) respectively; and
obtain the σ_{B} according to the s_{B} and the r_{B} corresponding to the session key negotation apparatus, the P_{A} and the x_{A} corresponding to the second user equipment, the d, and the e using a formula σ_{B}=gg(x_{A}+dgP_{A})g(r_{B}+egs_{B})∈R_{q}, the a∈R_{q}=¢_{q}[ζₘ]; the r_{B}←χ, the f_{B}←χ, the R comprising a cyclotomic ring, the R_{q} comprising a quotient ring defined on
$$R = ¢ [ {ζ}_{m} ] = \frac{¢ [ x ]}{{Φ}_{m} ( x )} ,$$
and the m comprising a positive integer.

10. The apparatus of claim 9, wherein the processor is further configured to obtain a long-term public key (P_{B}) corresponding to the session key negotiation apparauts according to s₁ and e₁ using a formula P_{B}=ags₁+e₁∈R_{q}, the transceiver being further configured to send a registration request carrying the P_{B} to an authentication center to authenticate that the P_{B}≠0 such that when authenticating, according to the registration request, that the P_{B}≠0, the authentication center obtains b_{c}, [v]₂, and [symbol] v [symbol] ₂ according to s, e, and e′ using formulas b_{c}=ags+e and v=ggbgs+e′, and returns the b_{c} and the [symbol] v [symbol] ₂ to the session key negotiation apparatus, the processor being further configured to obtain the w according to the received b_{c} and the [symbol] v [symbol] ₂ using formulas u=ggb_{c}gs₁ and w=rec(u, [symbol] v [symbol] ₂), the transceiver being further configured to send the w to the authentication center to authenticate that the w=[v]₂ such that when authenticating that the w=[v]₂, the authentication center sends a first certificate (Cert_{B}) to the session key negotiation apparatus to certify that the session key negotiation apparatus owns the P_{B}, s₁, the e₁←χ, the s, the e, and the e′←χ.

11. The apparatus of claim 10, wherein the transceiver is further configured to send the P_{B}, the y_{B}, and the v_{B} of the session key negotiation apparatus to the second user equipment to enable the second user equipment to obtain the K within a preset error range according to another long-term private key (s_{A}) and the x_{A} corresponding to the second user equipment, the P_{B}, the y_{B}, and the v_{B}, the preset error range comprising
$$[ - \frac{q}{8} , \frac{q}{8} ) .$$

12. A session key negotiation apparatus, comprising:
a transceiver configured to receive a long-term public key (P_{B}), a semaphore (v_{B}), and a temporary private key (y_{B}) of a first user equipment equipment, the first user equipment perforating a session negotiation with the session key negotiation apparatus; and
a processor coupled to the transceiver and configured to:
obtain a vector (σ_{A}) according to a long-term private key (s_{A}) and another temporary private key (r_{A}) corresponding to the session key negotiation apparatus, the P_{B}, and the y_{B}; and
obtain a session key (K) corresponding to the session key negotiation apparatus within a preset error range according to the σ_{A} and the v_{B} using a formula K=rec(σ_{A},v_{B}) to ensure security of the K, the preset error range comprising
$$[ - \frac{q}{8} , \frac{q}{8} ) ,$$
and the q comprising an even number not equal to two.

13. The apparatus of claim 12, wherein the processor is further configured to:
obtain a temporary public key (x_{A}) according to system parameters a and f_{A} using a formula x_{A}=agr_{A}+f_{A}∈R_{q};
obtain d and e according to the P_{B} and the x_{A} corresponding to the first user equipment, the y_{B}, identity information corresponding to the first user equipment (B), and identity information corresponding to the session key negotiation apparatus (A) using formulas d=H(x_{A},B) and e=H(y_{B},A) respectively; and
obtain the σ_{A} according to the s_{A} corresponding to the session key negotiation apparatus, the P_{B} and the y_{B} corresponding to the first user equipment, the d, and the e using a formula σ_{A}=gg(y_{B}+dgP_{B})g(r_{A}+egs_{A})∈R_{q}, the a∈R_{q}=¢_{q}[ζₘ], the r_{A}←χ, the f_{A}←χ, the g comprising a system parameter, and g∈R, the R comprising a cyclotomic ring, the R_{q} comprising a quotient ring defined on
$$R = ¢ [ {ζ}_{m} ] = \frac{¢ [ x ]}{Φ ( x )} ,$$
and the m comprising a positive integer.

14. The apparatus of claim 13, wherein the processor is further configured to obtain a long-term public key (P_{A}) corresponding to the session key negotiation apparatus according to s₁ and e₁ using a formula P_{A}=ags₁+e₁∈R_{q}, the transceiver being further configured to send a registration request carrying the P_{A} to authentication center to authenticate that the P_{A}≠0, such that when authenticating, according to the registration request, that the P_{A}≠0, the authentication center obtains b_{c}, [v]₂, and [symbol] v [symbol] ₂ according to s, e, and e′ using formulas b_{c}=ags+e and v=ggbgs+e′, and returns the b_{c} and the [symbol] v [symbol] ₂ to the session key negotiation apparatus, the processor being further configured to obtain w according to the received b_{c} and the [symbol] v [symbol] ₂ using formulas u=ggb_{c}gs₁ and w=rec(u, [symbol] v [symbol] ₂), the transceiver being further configured to send the w to the authentication center to authenticate that the w=[v]₂ such that when authenticating that the w=[v]₂, the authentication center sends a second certificate (Cert_{A}) to the session key negotiation apparatus to certify that the session key negotiation apparatus owns the P_{A}, the s₁, the e₁←χ, the s, the e, and the e′←χ.
